(19) United States
(12) Patent Application Publication
(10) Pub. No.: US 2011/0261692 A1
(43) Pub. Date: Oct. 27, 2011

(54) METHOD FOR BALANCING LOADS IN MOBILE WIRELESS AD-HOC NETWORKS

(76) Inventors: Josep Maria Pujol Serra, Barcelona (ES); Alberto Lopez Toledo, Barcelona (ES); Pablo Rodriguez, Barcelona (ES)

(21) Appl. No.: 12/764,363

(22) Filed: Apr. 21, 2010

(51) Int. Cl. H04W 28/02; H04L 12/56; H04W 24/00; H04L 12/26

(52) U.S. Cl. 370/230.1; 370/252; 370/338; 370/400

(57) ABSTRACT

The invention relates to a method for balancing the traffic load without affecting the performance or efficiency or efficiency in Pocket Switched Networks, comprised within the so-called Delay-Tolerant Networks. The method introduces the concepts of strength and affinity to make decisions for routing messages in the Pocket Switched Network.

### FIELD OF THE ART

The present invention is comprised within the field of wireless communications, particularly, in the field of mobile ad-hoc networks. This field is known as Pocket Switched Networks (PSN) or Delay-Tolerant Networks (DTN), in which each terminal is an IP node, i.e., it has the capability to not only send and receive data packets like a terminal node, but of routing packets with other destinations to other nodes, acting as a router of packets or messages from third parties that are neither the origin nor the destination.

By taking advantage of the proximity opportunities that the mobility itself of the users provides, this “network” of mobile nodes truly has a topology that continuously changes with its movement, such that routing “opportunities” turn up at a given time, therefore they are referred to as Ad-Hoc Networks, and in which the switching occurs in terminal devices which the users carry in their pockets, hence the name Pocket Switched Networks.

The proposed invention proposes a method for balancing the traffic load without affect the performance or efficiency. This method is referred to as FairRoute.

### STATE OF THE ART

After a search of the technical background, no relevant patent documents relating to the invention were found.

A document was found at Internet address www.cl.cam.ac.uk/˜ph315/publications/wac05.pdf which is quite illustrative for understanding the concepts on which the invention is based, but it does not affect the novelty and inventive step thereof.

Other various documents relating to the routing processes for mobile wireless ad-hoc networks are known today, but they do not including the fair route meaning. The following can be mentioned among them:
[1] A. Vandat and D. Becker. Epidemic routing for partially connected ad-hoc networks. Technical Report CS-200006, Duke University, 2000.
[2] E. Daly and M. Haahr. Social network analysis for routing in disconnected delay-tolerant MANETS. In Proc. of ACM MobiHoc, 2007.
[3] A. Lindgren, A. Doria, and O. Schelen. Probabilistic Routing in intermittently connected networks, volume 3126, pages 239-254. 2004.
[4] P. Hui, J. Crowcroft, and E. Yoneki. Bubble rap: Social based forwarding in delay tolerant networks. In Proc. of MobiHoc, 2008.

The following documents relate to the fair route meaning using methods different from the one herein described, in various different application domains:
[5] L. Tassiulas. Adaptive back-pressure congestion control based on local information. IEEE Transaction on Automatic Control, 40(2):236, 1995.
[6] B. Hull, K. Jamieson, and H. Balakrishnan. Mitigating congestion in wireless sensor networks. In Proc. of 2nd International Conference on Embedded Networks Sensor Systems, pages 134-147, 1994.
[7] S. Floyd. Tcp and explicit congestion notification. ACM Computer Communication Review, 24(5):10-23, 1994.

### DESCRIPTION OF THE INVENTION

### Technical Problem Considered

Pocket Switched Networks (PSN) trust the store-transport-forward scheme to work. The messages are sent from one cellular telephone to another through its wireless capabilities until it reaches a destination without using the network infrastructure. The messages are exchanged based on encounters by proximity.

All the methods existing until today use a best next hop policy to forward messages: a message m is forwarded from the cellular telephone i to cellular telephone j, if the probability of j finding destination z is greater than the probability of i.

In the PSN, the focus of the prior art (see references [1-4]) has been to identify methods and techniques for calculating this probability.

The best next hop policy maximizes the performance and efficiency, without studying the impact on scalability and reliability, which are critical factors in the PSN and this is what the method of the present application covers.

Forwarding in PSN is based on proximity contacts between people which is defined as contact tracking. It is known that the topology of contact tracking has a correlation with social networks, which have a biased connectivity distribution, in which a few nodes have many connections while most of them have very little. Since the messages are forwarded through the contacts, it is inevitable for the most connected nodes to carry most of the traffic, and therefore generating an unfair load distribution, which is neither scalable nor robust.

Furthermore, the natural problem of the imbalance of the load in a social network is only reinforced when the forwarding is not performed randomly, but rather is based on the heuristics of the best next hop (as is done in the current state of the art). This heuristics, the objective of which is to increase the performance and efficiency, tilts the forwarding towards those people who are more connected and more in the center of the network, which results in an additional imbalance of the load imposed on these people.

In other systems having similar topology properties, such as Internet, air traffic or highway networks, the problem with imbalance is solved by improving the resources of the nodes which are bottlenecks, for example by installing more switching centers, building more eight-lane highways or expanding airports with more terminals. However, this solution cannot be implemented in the entire system of a PSN, because each individual node belongs to a different administrative domain (i.e., to individual users). Furthermore, the mobile telephone market is fairly homogenous in terms of resource consumption, such as the duration of batteries, Therefore, unlike other systems, the natural imbalance due to the structure of the network cannot be compensated by assuming that all nodes which are bottlenecks will be improved.

This problem with imbalance is what is approached by this patent application.

### Solutions to this Problem Presented by the Invention

The object of the invention is a method providing a balance in the load of the traffic in a Pocket Switched Network without any negative impact on the performance or the efficiency. This method, hereinafter FairRoute, is based on two parts:

1) Strength of the Interaction in Various Time Scales

The perceived strength of the interaction, which is a concept developed by social influence, represents the subjective assessment of the strength of a social bond between two individuals. The strength of the interaction can be used as an indicator of the probability of a contact to be maintained over time. FairRoute uses two different estimators of the strength of the interaction working in different time scales: σᵢⱼ indicating the short-term interaction between i and j, and λᵢⱼ indicating the strength of the interaction in a longer time scale. The strength of the interaction ij increases with contact, but decreases over time at an exponential rate r_{σ} and r_{λ} for the strength of the short-term and long-term interaction, respectively. For this reason, it is necessary that r_{λ}<<r_{σ}. When contact between i and j occurs, the nodes update their perceived strengths of interaction as follows:

σᵢₖ=σᵢₖe^{-τ}^{_{σ}}^{(t-t}^{ᵢ}⁾ ∀_{kεN}_{ᵢ}, (1)

λᵢₖ=λᵢₖe^{-τ}^{_{λ}}^{(t-t}^{ᵢ}⁾ ∀_{kεN}_{ᵢ}, (2)

(σᵢⱼ,λᵢⱼ)=(σᵢⱼ,λᵢⱼ)+(1, 1), (3)

wherein Nᵢ is the list of contacts of node i, tᵢ is the time of the last contact of i (with any other node), and t is the current time. With contact, the node i updates the exponential reduction of the perceived strength with all the nodes encountered in the past (Nᵢ); it increased by 1 the strength of the interactions with node j (both long- and short-term interactions), and finally the time at which the last contact (tᵢ=t) is updated. The accumulated strength of the interaction sᵢⱼ between the nodes i and j is then defined as sᵢⱼ=λᵢⱼ (λᵢⱼ−σᵢⱼ). Instinctively, the accumulated strength of the interaction is an indication of the frequency of long-term interactions (proportionality to λᵢⱼ), at the same time it penalizes spurious bursts of activity (proportionality to the difference between the long- and short-term time scales (λᵢⱼ−σᵢⱼ).

uᵢⱼₖ is defined as the perceived utility of node j to deliver a message to node k,

$${u}_{ijk} = \frac{{λ}_{jk} ( {λ}_{jk} - {σ}_{jk} )}{{λ}_{jk} ( {λ}_{jk} - {σ}_{jk} ) - {λ}_{ik} ( {λ}_{ik} - {σ}_{ik} )} , \qquad ( 4 )$$

which represents that used in node j to deliver a message to k, as it is seen by node i, normalized by the total utility. For values of uᵢⱼₖ>0.5, it is expected that node j will work better than when i delivers a message to k. The utility uᵢⱼₖ is defined only when λᵢⱼ+λⱼₖ>0, in another case it is set to zero. Similarly, uᵢⱼ is the utility perceived by i of node j to deliver a message to any node defined as

$${u}_{ij} = \frac{{\sum }_{k ∈ {N}_{j}} {λ}_{jk} ( {λ}_{jk} - {σ}_{jk} )}{{\sum }_{k ∈ {N}_{j}} {λ}_{jk} ( {λ}_{jk} - {σ}_{jk} ) + {\sum }_{k ∈ {N}_{i}} {λ}_{ik} ( {λ}_{ik} - {σ}_{ik} )} \qquad ( 5 )$$

Finally, node i will forward to j a message the destination of which is k, if and only if

$$\{ \begin{matrix}{u}_{ijk} > \frac{1}{2} & ⋀ & ( {λ}_{ik} + {λ}_{jk} ) > 0 \\ {u}_{ij} > \frac{1}{2} & ⋀ & ( {λ}_{ik} + {λ}_{jk} ) = 0\end{matrix} \qquad ( 6 )$$

The symbol ̂ is the Boolean operator and: both conditions must be met to activate the rule. It must be observed that for the purpose of calculating the utilities uᵢⱼₖ, the users only exchange the perceived strength of their interaction in node k, but they never exchange the complete list of their contacts Nⱼ. For the purpose of obtaining Nⱼ, a node i must examine j for each possible value of k in a short time period (since the values of uᵢⱼₖ decrease over time). Then it is very easy for j to identify such attack and deny such additional communication with i.

2) Affinity-Based Queue Control

The heuristics of Equation 6 does not achieve a balanced distribution of the traffic; it even reinforces the natural imbalance of the load which is sought to be avoided with this method. The problem is based on the fact that the routing decision is still an ambitious maximization of the utility, in which forwarding is influenced towards the high connectivity nodes, such that in this regard, the method presented in this document has the same drawbacks as other methods in the state of the art. For the purpose of counteracting this effect, it is possible to again return to sociology and observe the mechanisms whereby people decide with whom to interact. Even at the risk of being stereotyped, it is an observed empirical fact that the social status of one's neighbors is a good indicator of his status. The reason is that since social interactions require resources which are limited, humans carefully choose what to spend their resources on and tend to assign them such that individual utility is maximized. In other words, people in the same class tend to interact with one another and tend to dispense with interactions with individuals with a lower social status.

For example, a renowned professor would assign time to review a preliminary work done by a similar colleague but he is unlikely to do the same for a graduate student. This behavior, known as affinity (or homophilia), is one of the driving factors behind the manner in which individuals interact with one another. Affinity is actually what makes social networks different from other complex networks. In order to capture the affinity in the algorithm of this invention, the social status of a node i of the DTN is defined as functionally equivalent to the size of the length Qᵢ of the queue of the node. The length of the queue can be interpreted as an indication that the node is often chosen to forward packets and, therefore, is a measurement of its popularity. It must be observed that popularity does not necessarily mean that the node works better, but just that the node is perceived as very useful. Since accepting the forwarding of a message has a cost, the nodes will only accept the forwarding request from those nodes of the same status or better. With affinity-based queue control, a node i would forward an addressed message k through j if it meets any of the following conditions

$$\{ \begin{matrix}( {u}_{ijk} > \frac{1}{2} ) & ⋀ & ( {λ}_{ik} + {λ}_{jk} ) > 0 & ⋀ & ( {Q}_{j} \leq {Q}_{i} ) \\ ( {u}_{ijk} = 1 ) & ⋀ & ( {λ}_{ik} + {λ}_{jk} ) > 0 & & \\ ( {u}_{ij } > \frac{1}{2} ) & ⋀ & ( {λ}_{ik} + {λ}_{jk} ) = 0 & ⋀ & ( {Q}_{j} \leq {Q}_{i} )\end{matrix} \qquad ( 7 )$$

High-status nodes will be able to forward messages more quickly due to their privileged position, whereas low-status nodes will have to find alternative paths. Since social and contact networks have a large number of paths between two nodes, the forwarding restrictions introduced by the affinity-based queue control do not necessarily involve a reduction in performance. On the other hand, it does not have a positive impact on the fairness of the routing method.

### BRIEF DESCRIPTION OF THE DRAWINGS

To complement the description being made and for the purpose of aiding to better understand the features of the invention according to a preferred practical embodiment thereof, a set of drawings is attached as an integral part of this description in which the following has been depicted with an illustrative and non-limiting character:

FIG. 1 shows the method describing the forwarding process.

FIG. 1.a is a flow chart depicting the distribution of the FairRoute load compared with other routing methods in the prior art, showing the load as a total number of forwarded messages.

FIG. 1.b is similar to the depiction of FIG. 1a but showing the distribution of the load as a number of transmissions (deliveries).

FIG. 2.a depicts the evaluation of the FairRoute performance and efficiency in comparison with other routing methods, measuring average performance achieved by various algorithms.

FIG. 2.b depicts the same as FIG. 2.a, but measuring the number of forwarded messages required to achieve the performance depicted in FIG. 2.a.

FIG. 2.c depicts the same as FIGS. 2.a and 2.b, but measuring the efficiency of various algorithms, as a ratio between the performance and the number of forwarded messages required.

### DETAILED DESCRIPTION OF THE INVENTION

### Preferred Embodiments

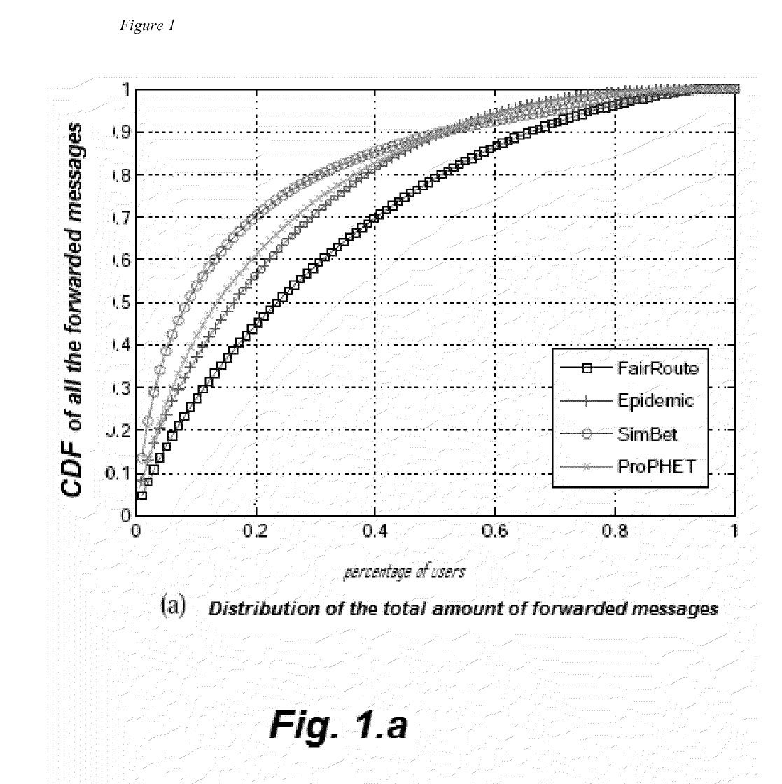

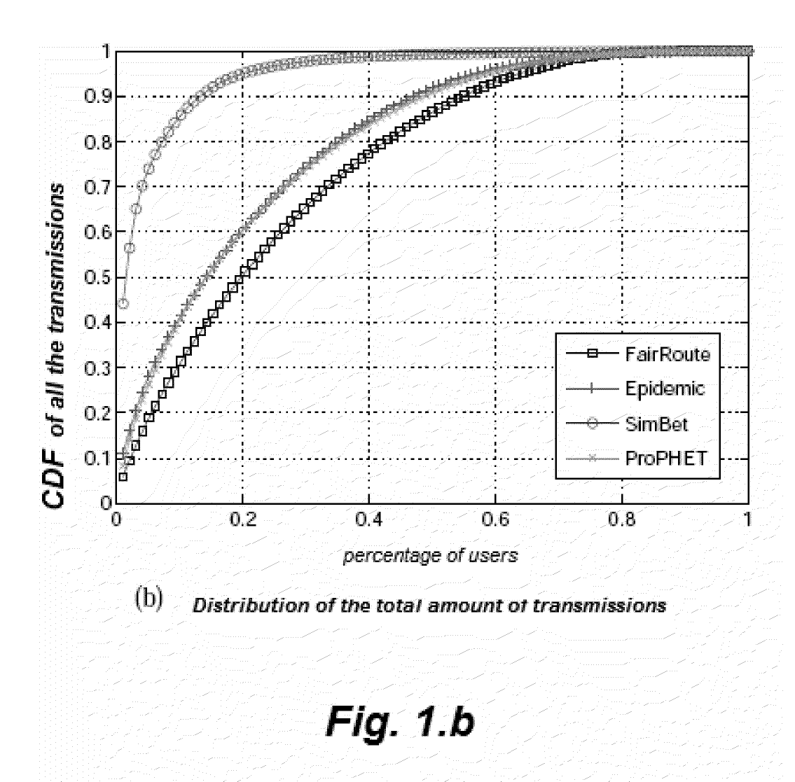

FIG. 1 shows the method describing the forwarding process, detailed below.

FIGS. 1.a and 1.b are graphs depicting the distribution of the FairRoute load in comparison with other routing methods in the prior art, specifically with Epidemic Routing [1], PROPHET [3] and Simbet [2]. FIG. 1.a shows the distribution of the load as the number of forwarded messages (traffic). In Simbet, 50% of the traffic passes through only 9 nodes, out of which the superior node handles 13.4%. PROPHET is better with 50% of the traffic managed by 14 nodes and the superior node handles 7.5% of the traffic load. This behavior can be extrapolated to all routing algorithms, based only on the heuristics of the best next hop, since this heuristics contributes to the already existing process of the combination of preferential traffic due to the topology of the network. The destination of the routing algorithms focused only on the best next hop heuristics is to increase the operation (performance and efficiency) at the cost of unfair traffic distributions. In addition, FairRoute has a load distribution which is fairer than the natural distribution of epidemic routing.

The affinity-based control (Equation 7) is able to distribute the traffic more fairly among all the users and, therefore, to affect the congestion and failure problems studied in the description of the invention. In FairRoute, 50% of the traffic is managed by 25% of the users, which is significantly higher than 9.3% of users in Simbet, 14.5% of users in PROPHET and 17.7% of users for epidemic routing.

FIG. 1.b shows the load distribution of as the number of transmissions (deliveries) and in which the same conclusions apply.

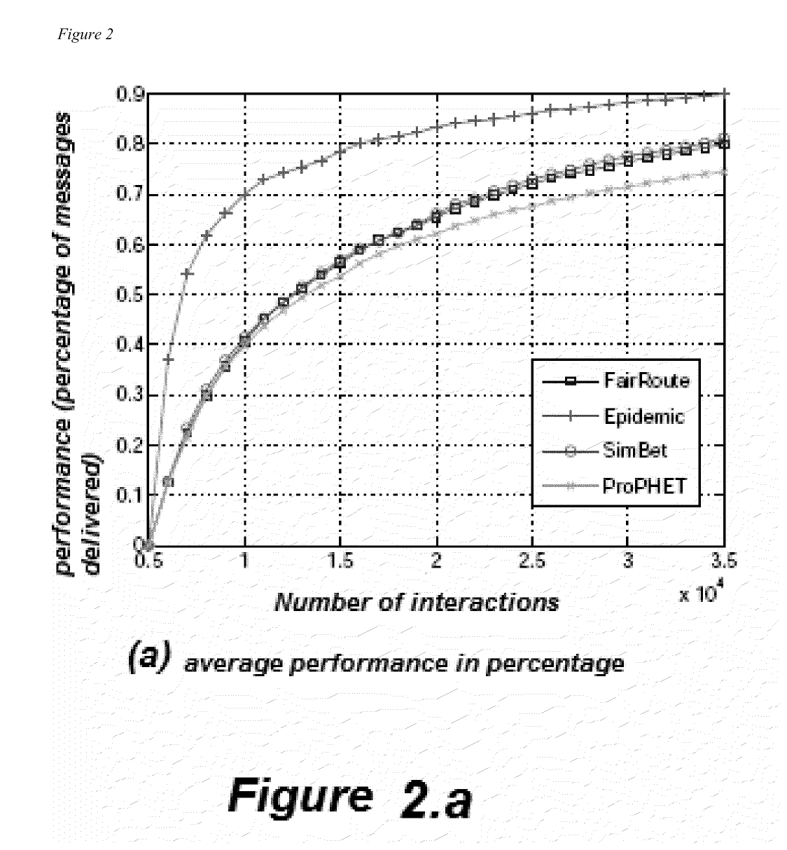

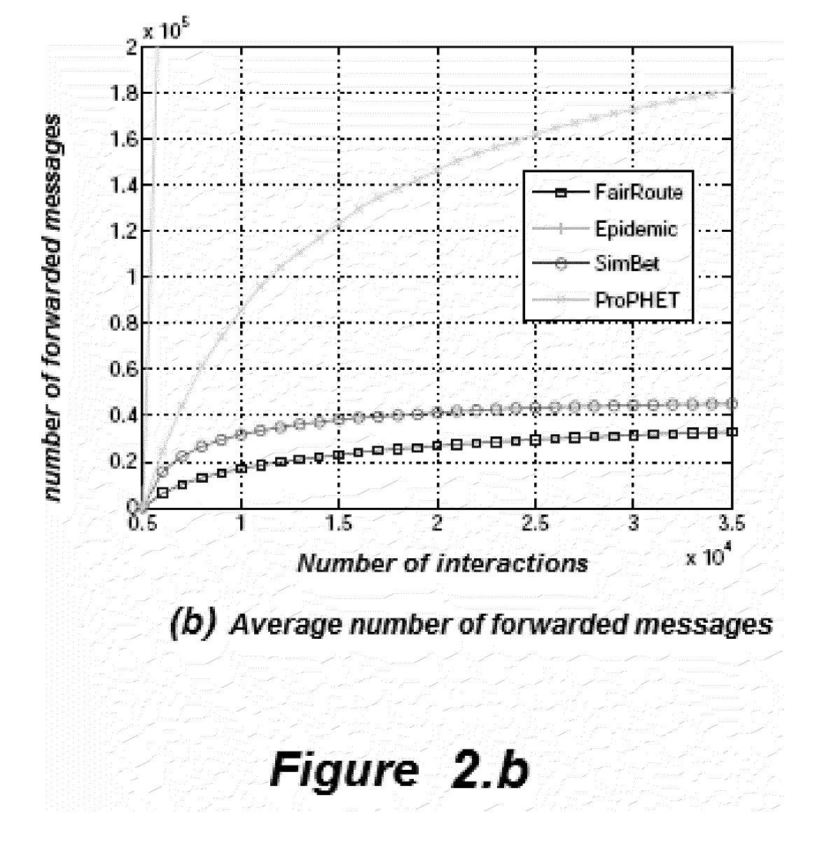

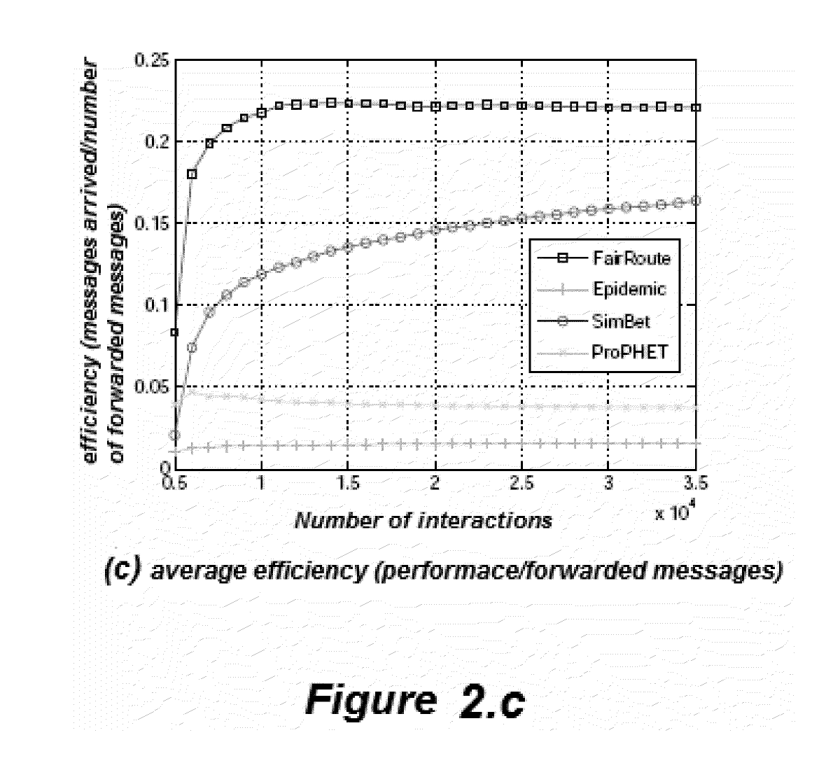

FIG. 2.a depicts the evaluation of the performance and efficiency of FairRoute in comparison with other routing methods, such as Epidemic Routing [1], PROPHET [3] and Simbet [2], measuring the average performance achieved by various algorithms.

FIG. 2.b depicts the same as FIG. 1.a, but measuring the number of forwarded messages required to achieve the performance depicted in FIG. 1.a.

FIG. 2.c measures the efficiency of the various algorithms as a ratio between the performance and the number of forwarded messages required. It can be observed that FairRoute is the most efficient algorithm. This feature is achieved by means of a drastic reduction of the forwarded messages provided by affinity-based control (Equation 7), while at the same time maintaining an acceptable performance as a result of the strength of the interaction in various time scales (see the section on solutions to the problem, in the description of the invention). In comparison with SimBet, FairRoute obtains a 33% increase in efficiency, at the expense of only 1.2% in a performance loss.

FIG. 1 shows the method describing the forwarding process.

Since node i encounters node j at time t, the strength of the interaction with all the nodes in N (equations 1 and 2) is updated in block 1. Then, the time tᵢ=t is updated in block 2.

In block 3, it is verified if i is in Nᵢ. If the answer is “yes”, it passes to block 4, in which the strength of the interaction is increased according to Equation 3. If the answer is “No”, it passes to block 5, in which all the messages of Qᵢ the destination of which is j are sent and all the messages are erased.

The utilities are calculated in block 6 (equations 4 and 5). This requires i and j to exchange summarized information about their query Q and their list of contacts N.

This leads to block 8 in which, for all the messages m of Qᵢ (block 7), the forwarding rule of Equation 7 is evaluated. If the answer is affirmative, it passes to block 9, in which the messages m are sent to j and are erased from Qᵢ. If the answer is “No”, a new message is processed, until they are all processed.

Nᵢ is the list of contacts of node i. Qᵢ is the queue of messages stored in the node i. See the previous description of the invention section for an additional description of the list of contacts and of the queue.

The classic embodiment is to have people carrying cellular telephones with Bluetooth or wireless capabilities. This method would allow scalable and reliable communication between these devices without the intervention of the network infrastructure.

However, this method is not limited to the communication between cellular telephones. Any device with (1) wireless capabilities and (2) with mobility can benefit from this method. This ranges from laptop computers to portable game consoles, and from vehicles to satellites. The networks under which this routing method is effective are those whose (3) connectivity is a challenge, and those under which (4) it is not necessary for there to be an end-to-end path between the source and the destination in the duration of a communications session. The routing method also depends on the wireless protocol, for example Bluetooth, 802.11, etc.

### INDUSTRIAL APPLICATION

Communication between nodes in environments without an existing network infrastructure. For example, the coordination of a group of robots for exploration, interplanetary Internet, etc. This invention can also be applied in those cases in which an existing network infrastructure is not available.

Ultimately, the method can also be applied as a complement of an existing network infrastructure to divert traffic from it and thus increase its capacity. This case is of especial interest for telecommunications companies who own their own network infrastructure, such as Telefonica. This method would allow companies to offer an alternative manner for handling data traffic which does not require an end-to-end path between the source and the destination in the duration of the communication session. The implementation of this method would effectively increase the capacity of the network without involving network improvement costs.

1. A method for balancing traffic load in a Pocket Switched Network comprising:
estimating strength of interaction between nodes in the network;
determining affinity of the nodes in the network; and
controlling queues of each of the nodes and balancing the traffic load based on the strength and the affinity

2. The method of claim 1 wherein the strength of interaction between the nodes is estimated at various time scales.

3. The method of claim 2, wherein two different estimators working in different time scales are used for the calculation of the strength of interaction, a first estimator indicating short-term interaction between the nodes, and a second estimator indicating long-term interaction between the nodes.

4. The method of claim 3, wherein the estimators decrease exponentially with the difference between a current time and a time of last contact between nodes.

5. The method of claim 4, wherein the estimators decrease over time at an exponential rate r_{σ} and r_{λ} for the estimators of the short-term and long-term interaction respectively, where r_{λ}<<r_{σ}.

6. The method of claim 1, wherein when the affinity of each of the node is calculated based on a social status of each of the node which is considered functionally equivalent to a length of the queue of said each node.

7. The method of claim 6, wherein the affinity is used to determine sharing, storage and forwarding of messages between the nodes.

8. The method of claim 1, wherein the network jointly uses the strength and affinity for routing messages in the network.

9. The method of claim 1, wherein the strength increases by one each time there is an interaction between two of the nodes.

10. The method of claim 3, wherein a utility measure is determined for the nodes based on the long-term and short-term interactions and a message is forwarded only if the utility measure exceeds a threshold.

11. The method of claim 1, where a node I would forward an addressed message to node k through a node j if it meets any of the following conditions:
$$\begin{matrix}\{ \begin{matrix}( {u}_{ijk} > \frac{1}{2} ) & ⋀ & ( {λ}_{ik} + {λ}_{jk} ) > 0 & ⋀ & ( {Q}_{j} \leq {Q}_{i} ) \\ ( {u}_{ijk} = 1 ) & ⋀ & ( {λ}_{ik } + {λ}_{jk} ) > 0 & & \\ ( {u}_{ij} > \frac{1}{2} ) & ⋀ & ( {λ}_{ik} + {λ}_{jk} ) = 0 & ⋀ & ( {Q}_{j} \leq {Q}_{i} )\end{matrix} \\ where & ( 7 ) \\ {u}_{ijk} = \frac{{λ}_{jk} ( {λ}_{jk} - {σ}_{jk} )}{{λ}_{jk} ( {λ}_{jk} - {σ}_{jk} ) - {λ}_{ik} ( {λ}_{ik} - {σ}_{ik} )} , & ( 4 ) \\ {u}_{ij} = \frac{{\sum }_{k ∈ {N}_{j}} {λ}_{jk} ( {λ}_{jk} - {σ}_{jk} )}{{\sum }_{k ∈ {N}_{j}} {λ}_{jk} ( {λ}_{jk} - {σ}_{jk} ) + {\sum }_{k ∈ {N}_{i}} {λ}_{ik} ( {λ}_{ik} - {σ}_{ik} )} & ( 5 ) \\ {σ}_{ik} = {σ}_{ik} {e}^{- {r}_{σ} ( t - {t}_{i} )} {∀}_{k ∈ {N}_{i}} , & ( 1 ) \\ {λ}_{ik} = {λ}_{ik} {e}^{- {r}_{λ} ( t - {t}_{i} )} {∀}_{k ∈ {N}_{i}} , & ( 2 ) \\ ( {σ}_{ij} , {λ}_{ij} ) = ( {σ}_{ij} , {λ}_{ij} ) + ( 1 , 1 ) , & ( 3 )\end{matrix}$$
Where r_{σ} and r_{λ} are constant for the strength of the short-term and long-term interaction respectively and Nᵢ is the list of contacts of node i, tᵢ is the time of the last contact of i (with any other node), and t is the current time and Qᵢ is the size of the length of the queue of the node i.

12. The method of claim 1, wherein the network is an ad-hoc network.

13. A Pocket Switched Network comprising:
a plurality of nodes;
a strength measure indicating the strength of interaction between the nodes;
an affinity measure indicating affinity of the nodes;
wherein the network controls queues of each of the nodes and balancing the traffic load based on the strength measure and the affinity measure.

14. The network of claim 13 wherein the strength of interaction between the nodes is estimated at various time scales.

15. The network of claim 14, wherein two different estimators working in different time scales are used for the calculation of the strength of interaction, a first estimator indicating short-term interaction between the nodes, and a second estimator indicating long-term interaction between the nodes.

16. The network of claim 15, wherein the estimators decrease exponentially with the difference between a current time and a time of last contact between nodes.

17. The network of claim 16, wherein the estimators decrease over time at an exponential rate r_{σ} and r_{λ} for the estimators of the short-term and long-term interaction respectively, where r_{λ}<<r_{σ}.

18. The network of claim 13, wherein when the affinity of each of the node is calculated based on a social status of each of the node which is considered functionally equivalent to a length of the queue of said each node.

19. The network of claim 18, wherein the affinity is used to determine sharing, storage and forwarding of messages between the nodes.

20. The network of claim 13, wherein the network jointly uses the strength and affinity for routing messages in the network.

21. The network of claim 13, wherein the strength increases by one each time there is an interaction between two of the nodes.

22. The network of claim 15, wherein a utility measure is determined for the nodes based on the long-term and short-term interactions and a message is forwarded only if the utility measure exceeds a threshold.

23. The network of claim 13, where a node i would forward an addressed message to node k through a node j if it meets any of the following conditions:
$$\begin{matrix}\{ \begin{matrix}( {u}_{ijk} > \frac{1}{2} ) & ⋀ & ( {λ}_{ik} + {λ}_{jk} ) > 0 & ⋀ & ( {Q}_{j} \leq {Q}_{i} ) \\ ( {u}_{ijk} = 1 ) & ⋀ & ( {λ}_{ik} + {λ}_{jk} ) > 0 & & \\ ( {u}_{ij} > \frac{1}{2} ) & ⋀ & ( {λ}_{ik} + {λ}_{jk} ) = 0 & ⋀ & ( {Q}_{j} \leq {Q}_{i} )\end{matrix} \\ where & ( 7 ) \\ {u}_{ijk} = \frac{{λ}_{jk} ( {λ}_{jk} - {σ}_{jk} )}{{λ}_{jk} ( {λ}_{jk} - {σ}_{jk} ) - {λ}_{ik} ( {λ}_{ik} - {σ}_{ik} )} , & ( 4 ) \\ {u}_{ij} = \frac{{\sum }_{k ∈ {N}_{j}} {λ}_{jk} ( {λ}_{jk} - {σ}_{jk} )}{{\sum }_{k ∈ {N}_{j}} {λ}_{jk} ( {λ}_{jk} - {σ}_{jk} ) + {\sum }_{k ∈ {N}_{i}} {λ}_{ik} ( {λ}_{ik} - {σ}_{ik} )} & ( 5 ) \\ {σ}_{ik} = {σ}_{ik} {e}^{- {r}_{σ } ( t - {t}_{i} )} {∀}_{k ∈ {N}_{i}} , & ( 1 ) \\ {λ}_{ik} = {λ}_{ik} {e}^{- {r}_{λ} ( t - {t}_{i} )} {∀}_{k ∈ {N}_{i}} , & ( 2 ) \\ ( {σ}_{ij} , {λ}_{ij} ) = ( {σ}_{ij} , {λ}_{ij} ) + ( 1 , 1 ) , & ( 3 )\end{matrix}$$
Where r_{σ} and r_{λ} are constant for the strength of the short-term and long-term interaction respectively and Nᵢ is the list of contacts of node i, tᵢ is the time of the last contact of i (with any other node), and t is the current time and Qᵢ is the size of the length of the queue of the node i.

24. The network of claim 13, wherein the network is an ad-hoc network.
